(19) United States
(12) Patent Application Publication
(10) Pub. No.: US 2014/0236675 A1
(43) Pub. Date: Aug. 21, 2014

(54) INFORMATION PROCESSING APPARATUS, INFORMATION PROCESSING METHOD, INFORMATION PROCESSING PROGRAM, AND RECORDING MEDIUM

(71) Applicant: Takashi Yokomichi, Shinagawa-ku (JP)

(72) Inventor: Takashi Yokomichi, Shinagawa-ku (JP)

(73) Assignee: RAKUTEN, INC., Shinagawa-ku, Tokyo (JP)

(21) Appl. No.: 14/347,923

(22) PCT Filed: Apr. 2, 2012
(86) PCT No.: PCT/JP2012/058896

§ 371 Date: Mar. 27, 2014

(30) Foreign Application Priority Data
Sep. 30, 2011 (JP) 2011-215975

(51) Int. Cl. G06Q 30/02

(52) U.S. Cl. CPC G06Q 30/0202
USPC 705/7.31

(57) ABSTRACT

A demand for transaction objects is more accurately predicted. An information processing apparatus includes: an acquiring means that acquires a plurality of pieces of reference list information from a storing means that stores, for each user, reference list information indicating transaction objects registered by users in a reference list that stores references to information on transaction objects; and a predicting means that predicts a demand for transaction objects based on the reference list information acquired by the acquiring means.

### TECHNICAL FIELD

The present invention relates to the technical field of information processing apparatuses that predict demands for transaction objects.

### BACKGROUND ART

Conventionally, when selling transaction objects such as an item or a service, the demands for transaction objects are predicted. Such prediction is performed based on, for example, past sales results of transaction objects. Specifically, as the past sales volume is larger, the predicted demand becomes larger, or the demand is predicted according to the behavior of a change in the past sales volume.

Also, Patent Literature 1 discloses a technique of predicting a demand for an item based on the number of accesses to a website on which an article associated with the item is posted.

### PRIOR ART LIST

### Patent Literature

Patent Literature 1: JP 2007-034967 A

### SUMMARY OF THE INVENTION

### Problem to be Solved by the Invention

However, it cannot be said that the demand prediction based on past sales results can predict the demand accurately. This is because, since a sales volume is influenced by factors such as the price of a transaction object or the presence of items in stock, the sales volume may often do not reflect the user's demand accurately. Moreover, as disclosed in Patent Literature 1, it cannot be said that the demand prediction based on the number of accesses to information on a transaction object can predict the demand accurately. This is because it cannot always be said that a user having accessed the information on a transaction object is interested in purchasing the transaction object.

The present invention has been made in view of the above points and is directed to provide an information processing apparatus, an information processing method, an information processing program, and a recording medium, capable of predicting demands for transaction objects more accurately.

### Means for Solving the Problem

In order to solve the above problem, the invention according to claim 1 is an information processing apparatus comprising:

an acquiring means that acquires a plurality of pieces of reference list information from a storing means that stores, for each user, reference list information indicating transaction objects registered by users in a reference list that holds references to information on transaction objects; and

a predicting means that predicts a demand for a transaction object based on the reference list information acquired by the acquiring means.

A transaction object registered in the reference list by a user has a probability to be purchased by the user. According to this invention, since the demand is predicted based on the reference list information indicating the transaction object that has a probability to be purchased, the demand can be more accurately predicted.

The invention according to claim 2 is the information processing apparatus according to claim 1,

wherein the predicting means predicts sizes of demands for a plurality of transaction objects whose at least one set of classes among a plurality of classes of transaction objects belong to the same class.

According to this invention, it is possible to compare the demands for a plurality of transaction objects.

The invention according to claim 3 is the information processing apparatus according to claim 1 or 2,

wherein the predicting means predicts a demand for a transaction object based on the reference list information acquired by the acquiring means and a deletion history stored in a deletion history storing means that stores a deletion history of the transaction object from the reference list by the user.

A transaction object deleted from the reference list by the user has a probability that the user will lose interest in purchasing. According to this invention, it is possible to improve the demand prediction accuracy by taking the history of transaction objects deleted from the reference list further into consideration.

The invention according to claim 4 is the information processing apparatus according to any one of claims 1 to 3, further comprising:

a determining means that determines whether a class to which a demand prediction target transaction object belongs among a plurality of classes of transaction objects is such a class of transaction objects for which a plurality of transaction objects is purchased in the same period by one user; and

a number-of-registrations acquiring means that acquires, for each user, a number of registrations in the reference list, of transaction objects of the class to which the prediction target transaction object belongs,

wherein the specifying means calculates the sum of demands for the prediction target transaction object, of respective users, which has been registered in the reference list, predicts a demand corresponding to the sum, sets a predetermined demand as the demand of each user when the determining means determines that the class of the transaction object is such a class for which a plurality of transaction objects are purchased, and sets the demand of each user based on the number of registrations acquired for each user by the number-of-registrations acquiring means when the determining means determines that the class of the transaction object is not such a class for which a plurality of transaction objects is purchased.

According to this invention, when the demand for transaction objects belonging to such a class that only one item is purchased by one user at the same time period is predicted, the demand of the user is predicted based on the number of transaction objects belonging to that class, registered in the reference list by the user. Due to this, even when a plurality of transaction objects of such a class is registered in a reference list of one user, since the demand can be predicted by taking the fact that the user is highly probable to purchase only one transaction object among the plurality of transaction objects into consideration, it is possible to improve the demand prediction accuracy.

The invention according to claim 5 is the information processing apparatus according to claim 4, further comprising:

a number-of-purchases acquiring means that acquires, for each user, the number of purchases, in the same period, of transaction objects of a class to which the prediction target transaction object belongs based on a purchase history stored in a purchase history storing means that stores information indicating the class of a transaction object purchased by the user, information indicating the user who has purchased the transaction object, and a purchase date and time in association with each other as a purchase history; and

a number determining means that determines, for each user, whether the number of purchases acquired by the number-of-purchases acquiring means is equal to or larger than the number of registrations acquired by the number-of-registrations acquiring means,

wherein when the determining means determines that the class of the transaction object is such a class for which a plurality of transaction objects are purchased, the specifying means sets the predetermined demand as the demand of a user whose number of purchases is determined by the number determining means to be equal to or larger than the number of registrations, and sets a demand smaller than the predetermined demand as the demand of a user whose number of purchases is determined by the number determining means to be smaller than the number of registrations based on the number of purchases and the number of registrations.

According to this invention, when the demand for transaction objects belonging to such a class that a plurality of items may be purchased by one user at the same time period is predicted, the number of transaction objects of that class, purchased by the user in the same period is acquired based on the purchase history. When the number of transaction objects purchased is smaller than the number of transaction objects of that class, registered in the reference list by the user, the demand of the user is predicted to be smaller than a predetermined demand based on the number of transaction objects purchased and the number of transaction objects registered in the reference list. Due to this, when a plurality of transaction objects of such a class is registered in a reference list of one user, since the demand can be predicted by taking the purchasing trends of the respective users into consideration, it is possible to improve the demand prediction accuracy.

The invention according to claim 6 is the information processing apparatus according to any one of claims 1 to 5, further comprising:

a share acquiring means that acquires a market share of a demand prediction target transaction object, of a seller who has requested demand prediction among a plurality of sellers who sells the demand prediction target of transaction object,

wherein the predicting means predicts a demand of the seller who has requested demand prediction based on the reference list information acquired by the acquiring means and the market share acquired by the share acquiring means.

According to this invention, it is possible to predict the demand of a seller who wants to know a demand.

The invention according to claim 7 is an information processing method, which is executed by a computer, comprising:

an acquiring step of acquiring a plurality of pieces of reference list information from a storing means that stores, for each user, reference list information indicating transaction objects registered by users in a reference list that holds references to information on transaction objects; and

a predicting step of predicting a demand for a transaction object based on the reference list information acquired in the acquiring step.

The invention according to claim 8 is an information processing program, which causes a computer included in an information processing apparatus to function as:

an acquiring means that acquires a plurality of pieces of reference list information from a storing means that stores, for each user, reference list information indicating transaction objects registered by users in a reference list that holds references to information on transaction objects; and

a predicting means that predicts a demand for a transaction object based on the reference list information acquired by the acquiring means.

The invention according to claim 9 is a recording medium storing a computer-readable information processing program thereon, which causes a computer included in an information processing apparatus to function as:

an acquiring means that acquires a plurality of pieces of reference list information from a storing means that stores, for each user, reference list information indicating transaction objects registered by users in a reference list that holds references to information on transaction objects; and

a predicting means that predicts a demand for a transaction object based on the reference list information acquired by the acquiring means.

### Advantageous Effects of the Invention

According to the present invention, since the demand is predicted based on the reference list information indicating the transaction object that has a probability to be purchased, the demand can be more accurately predicted.

### BRIEF DESCRIPTION OF DRAWINGS

FIG. 1 is a diagram illustrating an example of a schematic configuration of an electronic commerce system S according to the present embodiment.

FIGS. 2A to 2E illustrate display examples of information indicating demand prediction results in an item demand prediction result page.

FIG. 3 is a block diagram illustrating an example of a schematic configuration of an electronic commerce server 1 according to the present embodiment.

FIG. 4A is a diagram illustrating an example of contents registered in a membership information DB 12a, FIG. 4B is a diagram illustrating an example of contents registered in a genre information DB 12b, FIG. 4C is a diagram illustrating an example of contents registered in a shop information DB 12c, FIG. 4D is a diagram illustrating an example of contents registered in an item information DB 12d, FIG. 4E is a diagram illustrating an example of contents registered in a browsing history DB 12e, FIG. 4F is a diagram illustrating an example of contents registered in a purchase history DB 12f, FIG. 4G is a diagram illustrating an example of contents registered in a bookmark information DB 12g, and FIG. 4H is a diagram illustrating an example of contents registered in a bookmark registration/deletion history DB 12h.

FIG. 5 is a flowchart illustrating a processing example of a demand prediction request reception process of a system control unit 14 of the electronic commerce server 1 according to the present embodiment.

FIG. 6 is a flowchart illustrating a processing example of a one-item demand prediction process of the system control unit 14 of the electronic commerce server 1 according to the present embodiment.

FIG. 7 is a flowchart illustrating a processing example of a one-user demand prediction process of the system control unit 14 of the electronic commerce server 1 according to the present embodiment.

### MODE FOR CARRYING OUT THE INVENTION

Hereinafter, embodiments of the present invention will be described in detail with reference to the drawings. Also, embodiments described below are embodiments in a case where the present invention is applied to an electronic commerce system.

### 1. Overview of Configuration and Function of Electronic Commerce System

### 1-1. Configuration of Electronic Commerce System

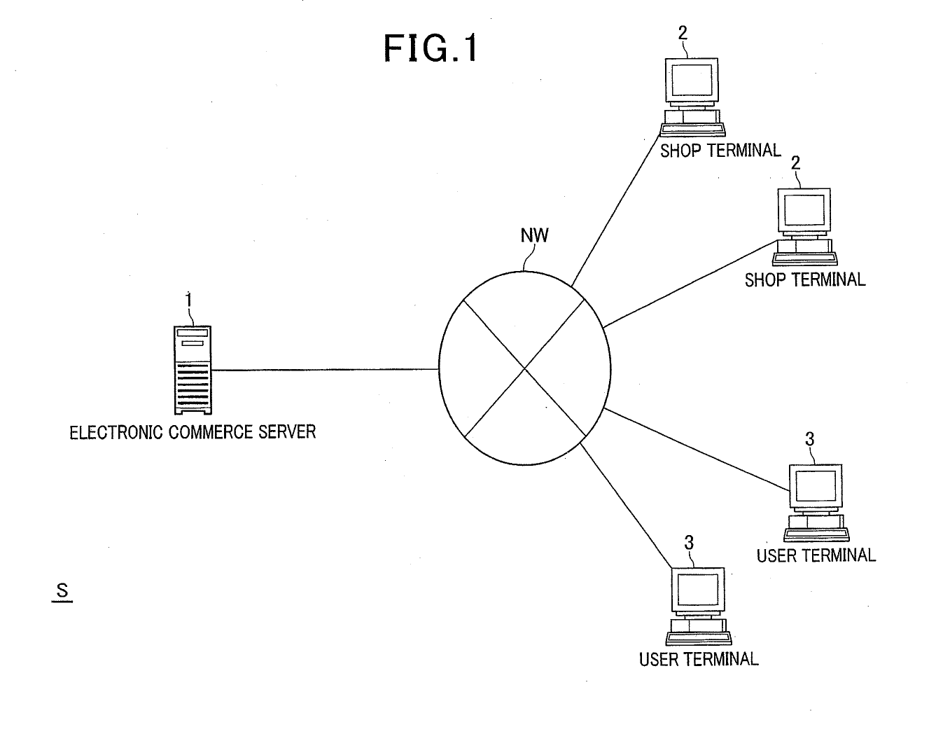

First, the configuration of an electronic commerce system S according to the present embodiment will be described with reference to FIG. 1. FIG. 1 is a diagram illustrating an example of a schematic configuration of the electronic commerce system S according to the present embodiment.

As illustrated in FIG. 1, the electronic commerce system S is configured to include an electronic commerce server 1, a plurality of shop terminals 2, and a plurality of user terminals 3. Moreover, the electronic commerce server 1, and the respective shop terminals 2 and the respective user terminals 3 can mutually transmit and receive data through a network NW by using, for example, TCP/IP or the like as a communication protocol. Also, the network NW is constructed by, for example, Internet, a dedicated communication line (for example, community antenna television (CATV) line), a mobile communication network (including a base station), a gateway, or the like.

The electronic commerce server 1 (an example of an information processing apparatus according to the present invention) is a server apparatus that performs various processes related to an online mall where users can purchase items. Users can purchase desired items from desired shops by using the online mall. The electronic commerce server 1 transmits a web page of an online mall or an auction and performs processes associated with retrieving, purchasing, and the like of items, for example, in response to a request from the shop terminal 2 or the user terminal 3.

The shop terminal 2 is a terminal device that is used by an employee or the like of a shop open in an online mall. The shop terminal 2 is used to, for example, register information on items for sales in the online mall and confirm contents of ordered items. Also, the shop terminal 2 accesses the electronic commerce server 1 based on an operation from an employee or the like, and receives and displays a web page from the electronic commerce server 1. Software such as a browser or an email client is incorporated into the shop terminal 2. A personal computer or the like, for example, is used as the shop terminal 2.

The user terminal 3 is a terminal device of a user who uses the online mall. The user terminal 3 accesses the electronic commerce server 1 based on an operation of a user, and receives and displays a web page from the electronic commerce server 1. Software such as a browser or an email client is incorporated into the user terminal 3. As an example of the user terminal 3, a personal computer, a personal digital assistant (PDA), a mobile information terminal such as a smartphone, a mobile phone, or the like is used.

### 1-2. Demand Prediction Based on Bookmark

The electronic commerce system S provides a bookmark function. The bookmark function is a function of registering an item sold in an online mall as a bookmark of a user to store a reference to an item page in a user-dedicated list so that the user can easily browse the item page of the bookmarked item. The item page is a web page in which detailed information on one item is displayed. Moreover, the bookmarked item is referred to simply as a bookmark. In an online mall, a hyperlink (hereinafter referred to as a “link”) displayed as “add to bookmark” is displayed in an item page. When a user selects this link, an item of which the information is displayed in the item page is registered in the bookmark of the user. The user can check the items registered in the bookmark in a bookmark page. The bookmark page is a web page in which a list of items registered in the bookmark is displayed and is a dedicated web page of each user. Moreover, a link to an item page of an item registered in the bookmark is embedded in the bookmark page. When the user selects a link to an optional item in the bookmark page, it is possible to display the corresponding item page. Moreover, the user can designate an item that does not need to be registered among the items registered in the bookmark of the bookmark page and delete the item from the bookmark.

The electronic commerce server 1 predicts a demand for an item sold in an online mall in response to a request from the shop terminal 2 and transmits a web page (hereinafter referred to as an item demand prediction result page) showing prediction results to the shop terminal 2. Specifically, the electronic commerce server 1 executes a process of predicting the demand for an item based on the bookmark. For example, an item that the user is interested in, an item that the user designates as a purchase candidate, an item that the user likes, and the like are registered in the bookmark. Thus, the items that the user registers in the bookmark are considered to be items that the user is more probable to purchase in the future than items that are not registered in the bookmark. That is, the bookmark can be said to indicate the future demand for an item. Thus, basically, the electronic commerce server 1 predicts that the larger the number of users (hereinafter referred to as “number of registrations”) who have registered a certain item in the bookmark, the larger is the demand for the item.

As a conventional demand prediction method, a method of predicting the demand based on a past sales volume is known. However, it cannot be said that the demand prediction based on the past sales volume can predict the demand accurately. This is because the sales volume is influenced by factors such as the price of an item or the presence of items in stock. Moreover, the past sales volume indicates the amount of demand consumed so far. That is, if the past sales volume is large, a large part of original demand may be consumed by the sales of items so far. In this case, the future sales volume may drop abruptly. In contrast, the bookmark-based demand prediction is not influenced by the price of an item or the presence of items in stock. Moreover, as described above, items that the user is probable to purchase in the future are registered in the bookmark. Thus, the bookmark-based demand prediction can predict the demand more accurately than the demand prediction based on the past sales volume.

Moreover, as a conventional demand prediction method, a method of predicting the demand based on the number of accesses to information on items such as an item page is known. It cannot be said that the demand prediction based on the number of accesses can predict the user's demand accurately. This is because a user who browses the item page is interested in purchasing an item of which the information is posted on the item page. For example, the user may have browsed the item page out of mere curiosity without any intention to purchase. Moreover, the user may check information posted on the item page and determine to exclude an item of which the information is posted on the item page from a purchase target. In contrast, the act of a user registering an item in a bookmark is highly probably an indication of intention that the user is interested in the item. Thus, the bookmark-based demand prediction can predict the demand more accurately than the demand prediction based on the number of accesses to the item page.

Next, a specific method of predicting the demand based on a bookmark will be described. The electronic commerce server 1 assumes that a certain item has a per-user demand per one user who has registered the item in a bookmark. The size of the per-user demand is set in advance by an administrator of the electronic commerce system S, for example. For example, the per-user demand may be one item or may be larger or smaller than one item. For example, it is assumed that one item is demanded by one user who has registered the item in the bookmark. Moreover, it is assumed that the number of registrations in the bookmark is 3000 and 2000 for items A and B, respectively. In this case, 3000 items and 2000 items are demanded for the items A and B, respectively.

The respective items each are classified by a genre. The genre (an example of a class according to the present invention) of items is a range to which items of the same type, property, use, or the like belong when items are classified by their types, properties, uses, or the like, for example. There is such a genre that a certain user would generally not purchase a plurality of items of that genre in the same period. An example of an item of such a genre is a refrigerator. If one family purchases one refrigerator, this family would generally not purchase another refrigerator in future several years. For example, it is assumed that a certain user has registered refrigerator items C, D, and E in a bookmark. In this case, it is not reasonable to say that the user has registered the items in the bookmark with an intention to purchase all items C, D, and E. In this case, it is highly probable that the user intends to purchase one from the items C, D, and E as purchase candidates. Thus, the probability of the item C to be selected as a purchased item among the items C, D, and E is ⅓ by simple calculation. When the item C is purchased actually, there is an actual demand for the item C, but there is no demand for the items D and E. Thus, it can be considered that the larger the number (hereinafter referred to a “number of same-genre registrations”) of items of such a genre that one user would generally not purchase a plurality of items in the same period, that a user has registered in a bookmark, the smaller the future demand for individual items.

Thus, the electronic commerce server 1 calculates a number of same-genre registrations of each user when predicting the demand for items of such a genre. Moreover, the electronic commerce server 1 sets the demand of each user based on the number of same-genre registrations. Specifically, the electronic commerce server 1 calculates the demand of each user by dividing a predetermined per-user demand by the number of same-genre registrations. That is, the electronic commerce server 1 calculates the demand of a user according to the following equation.

(Demand of certain user)=(Per-user demand)/(Number of same-genre registrations of the user)

Moreover, the electronic commerce server 1 predicts the demands of all users by summing up the demands calculated for the respective users.

On the other hand, when predicting the demand for items of such a genre that one user is probable to purchase a plurality of items in the same period, the electronic commerce server 1 may assume that one user has a predetermined per-user demand irrespective of the size of the number of same-genre registrations. For example, one user would probably purchase a plurality of dresses in the same period.

Alternatively, when predicting the demand for items of such a genre that one user would probably purchase a plurality of items in the same period, the electronic commerce server 1 may predict the demands of all users by calculating the demands of respective user based on the past purchasing trends of the users and summing up the calculated demands. Even if a user has registered a plurality of items of such a genre that one user would probably purchase a plurality of items in the same period in a bookmark, it cannot be said that all items registered would be purchased. How many items will be purchased in the same period is generally different from user to user. Thus, the electronic commerce server 1 calculates, for each user, the number (hereinafter referred to as a “number of same-period purchases”) of purchases in the same period for items of a genre to which a demand prediction target item belongs. Moreover, the electronic commerce server 1 determines that an item has a predetermined per-user demand when the number of same-period purchases is equal to or larger than the number of same-genre registrations. This is because, since the number of items purchased by a user in the same period is equal to or larger than the number of items registered in the bookmark, all items registered would probably be purchased by the user. That is, it is predicted that all items registered are in demand. On the other hand, when the number of same-period purchases is smaller than the number of same-genre registrations, the electronic commerce server 1 sets the demand of each user to be smaller than the predetermined per-user demand based on the number of same-period purchases and the number of same-genre registrations. Specifically, the electronic commerce server 1 calculates the demand of each user by multiplying the predetermined per-user demand by the number of same-period purchases and dividing the multiplication result by the number of same-genre registrations. That is, the electronic commerce server 1 calculates the following equation.

(Demand of certain user)=(Per-user demand)×(Number of same-period purchases of the user)/(Number of same-genre registrations of the user)

This is because it is predicted that a number of items purchased by the user in the same period among the items registered in the bookmark are in demand.

Moreover, the electronic commerce server 1 may record the history of items registered in the bookmark and the history of items deleted from the bookmark and predict the demand for items based on the histories and the bookmark. For example, the electronic commerce server 1 may correct the demand for items based on an amount of increase or decrease in the number of bookmark registrations of a demand prediction target item in a predetermined period (for example, from the present to one week before or one month before). If the number of bookmark registrations of a certain item has been decreasing so far, the number of registrations of the item would probably keep decreasing. Thus, the demand for such an item would probably still decrease. Thus, the electronic commerce server 1 may correct the demand for an item of which the number of bookmark registrations has decreased, for example, so that the larger the decrease, the smaller the corrected demand for the item than before correction. Moreover, the electronic commerce server 1 may correct the demand for an item of which the number of bookmark registrations has increased, for example, so that the larger the increase, the larger the corrected demand for the item than before correction.

Moreover, the electronic commerce server 1 may predict the demand for items based on the history of items deleted from the bookmark and the bookmark. For example, the electronic commerce server 1 may correct the demand for items based on the number of demand prediction target items deleted from the bookmark in a predetermined period. Specifically, the electronic commerce server 1 corrects the demand for an item so that the larger the number of items deleted, the smaller the corrected demand for the item than before correction.

Moreover, the electronic commerce server 1 may predict a demand (hereinafter referred to as a “shop demand”) for a shop that has requested demand prediction. The market share in an online mall, of a shop that has requested demand prediction can be calculated based on past sales results. Thus, the electronic commerce server 1 can predict the demand for a shop that has requested demand prediction by multiplying the market share by the demand (hereinafter referred to as a “gross demand”) of the entire online mall.

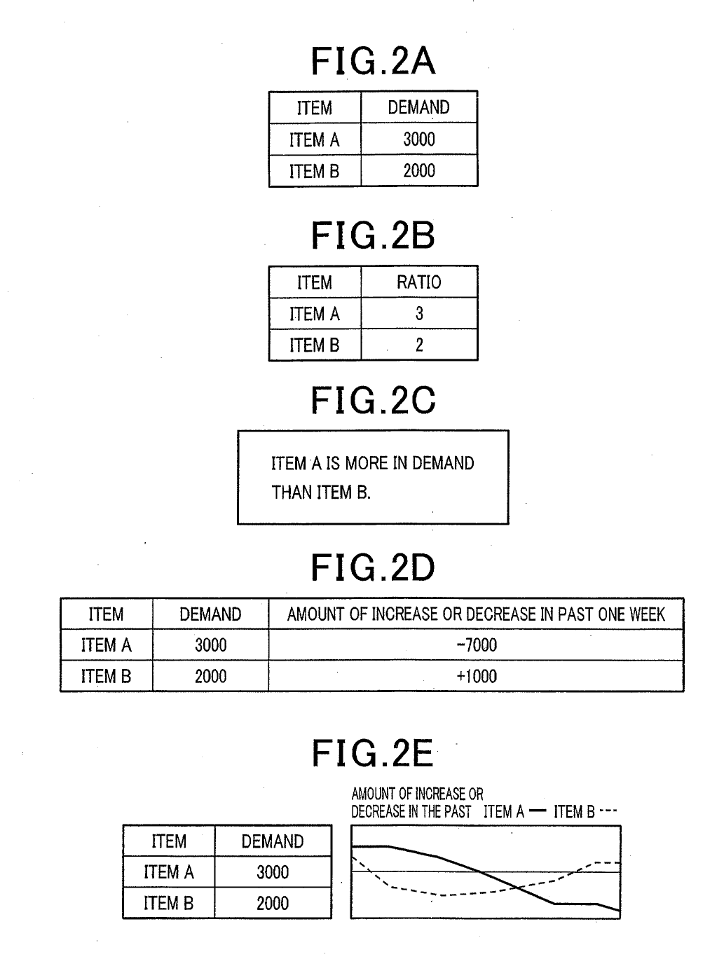

Next, a display example of information indicating the demand prediction results based on a bookmark will be described. FIGS. 2A to 2E illustrate display examples of information indicating the demand prediction results in an item demand prediction result page.

A plurality of pieces of information on the demands for a plurality of items may be displayed in an item demand prediction result page. In this case, when a plurality of items belonging to the same genre is present in the demand prediction target items, the electronic commerce server 1 predicts the sizes of the demands for a plurality of items so that the information indicating the sizes of the demands is displayed in the item demand prediction result page. This is because the demands of the plurality of items belonging to the same genre are compared by a shop. The shop compares the demands to determine which item is to be stocked and which item the shop has to focus on to sale.

For example, the electronic commerce server 1 may display the number of bookmark registrations of respective items as it is such that 3000 is for the item A and 2000 is for the item B as illustrated in FIG. 2A. Moreover, for example, the electronic commerce server 1 may display the ratio of demands such as (item A):(item B)=3:2, as illustrated in FIG. 2B. Further, the electronic commerce server 1 may display information indicating “Item A is more in demand than item B” as illustrated in FIG. 2C, and may display information indicating “(Item A)>(Item B)”. Furthermore, the electronic commerce server 1 may display the amount of increase or decrease in the numbers of bookmark registrations of respective items in a predetermined period together with information indicating the sizes of demands as illustrated in FIG. 2D. Furthermore, the electronic commerce server 1 may display a graph indicating a change in the amount of increase or decrease in the numbers of bookmark registrations of respective items together with information indicating the sizes of demands as illustrated in FIG. 2E.

When the past sales volume of a demand prediction target item in a shop that has requested demand prediction is considerably smaller than the demand predicted based on the bookmark, the sales may be not satisfactory due to some reasons (for example, a high price) even if there is a potential demand. Thus, the electronic commerce server 1 may display information corresponding to such a case. For example, information such as “3000 items are in demand for item A; however, the sales won't grow due to some reasons” may be displayed. The electronic commerce server 1 may display such information when the sales volume is equal to or smaller than a predetermined threshold or when the sales volume is equal to or smaller than a predetermined fraction of the predicted demand.

Moreover, the electronic commerce server 1 may display any one or both of the gross demand and the shop demand.

### 2. Configuration of Electronic Commerce Server

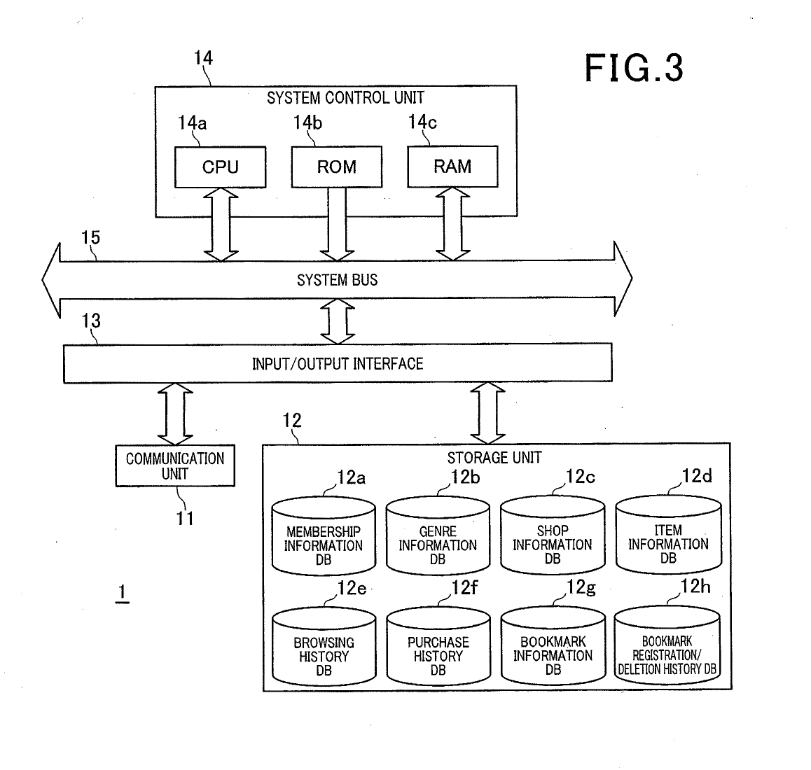

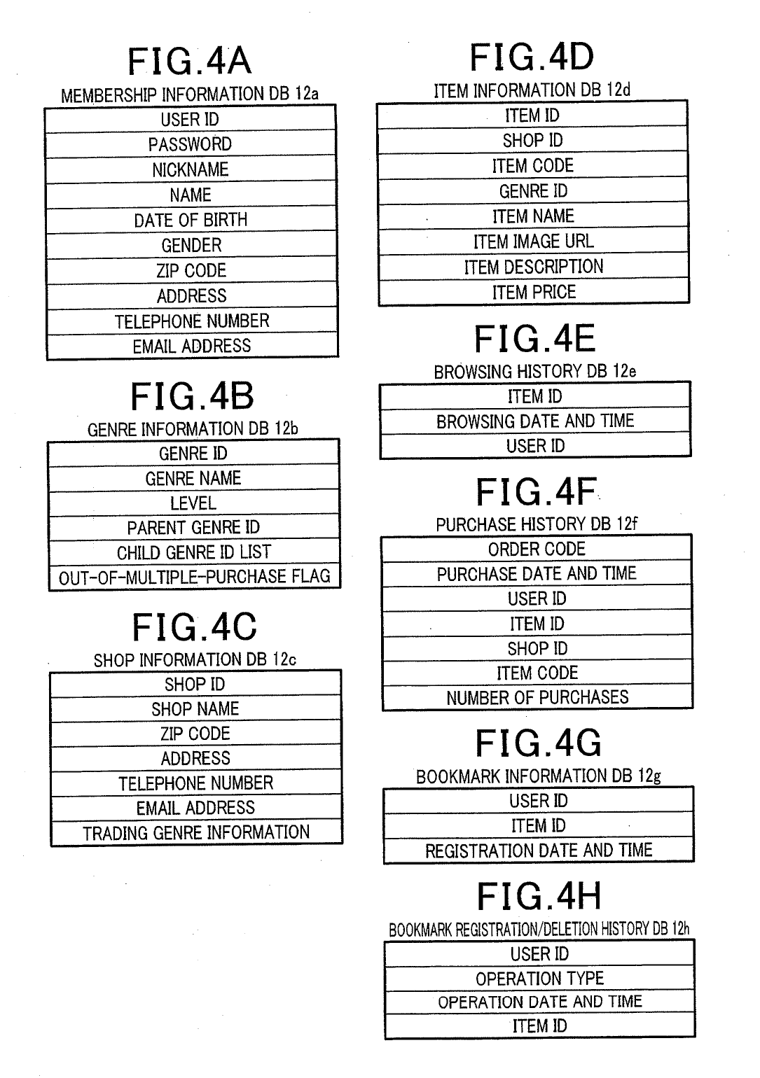

Next, the configuration of the electronic commerce server 1 will be described with reference to FIG. 3 and FIGS. 4A to 4H.

FIG. 3 is a block diagram illustrating an example of a schematic configuration of the electronic commerce server 1 according to the present embodiment. As illustrated in FIG. 3, the electronic commerce server 1 includes a communication unit 11, a storage unit 12, an input/output interface 13, and a system control unit 14. The system control unit 14 and the input/output interface 13 are connected through a system bus 15.

The communication unit 11 is configured to connect to a network NW to control the communication state with the shop terminals 2, the user terminals 3, and the like.

The storage unit 12 (an example of a storing means, a deletion history storing means, and a purchase history storing means according to the present invention) is configured by, for example, a hard disk drive or the like. Databases such as a membership information DB (database) 12a, a genre information DB 12b, a shop information DB 12c, an item information DB 12d, a browsing history DB 12e, a purchase history DB 12f, a bookmark information DB 12g, a bookmark registration/deletion history DB 12h, and the like are constructed in the storage unit 12.

FIG. 4A is a diagram illustrating an example of contents registered in the membership information DB 12a. Membership information of users registered in the electronic commerce system S as members is registered in the membership information DB 12a. Specifically, attributes of a user such as a user ID, a password, a nickname, a name, a date of birth, a gender, a zip code, an address, a telephone number, and an email address are registered in the membership information DB 12a in association with each user. The user ID is identification information of a user.

FIG. 4B is a diagram illustrating an example of contents registered in the genre information DB 12b. Genre information on the genre of an item is registered in the genre information DB 12b. Specifically, attributes of a genre such as a genre ID, a genre name, a genre level, a parent genre ID, a child genre ID list, and an out-of-multiple-purchase flag are registered in the genre information DB 12b in association with each genre. The genre information is set by, for example, an administrator or the like of an online mall.

Genres of items are defined hierarchically by a tree structure. Specifically, each node of a tree structure corresponds to a genre. The depth of a node corresponds to the level (class) of the genre corresponding to the node. The depth of a node is a distance from a node (hereinafter referred to as a “root node”) positioned at the root. As the level value is larger, the level depth becomes deeper, and as the level value is smaller, the level depth becomes shallower. A genre corresponding to a child node of the root node is a genre of level 1. The genre of level 1 is the highest genre. A genre corresponding to a child node among the genres of level 1 is defined as a genre of level 2. Herein, a genre C2 corresponding to a child node of a certain genre C1 at this time is referred to as a “child genre” of the genre C1. A child genre is also referred to as a sub-genre. Moreover, the genre C1 is referred to a “parent genre” of the genre C2. The child genre is a range to which the same items belong when the parent genre is further classified into a plurality of genres. Thus, the child genre belongs to a parent genre. Moreover, a genre corresponding to a descendant node of a certain genre is referred to an “descendant genre”. For example, it is assumed that genre C3 is a child genre of the genre C2. In this case, the genres C2 and C3 are descendant genres of the genre C1. Moreover, a genre corresponding to an ancestor node of a certain genre is referred to as an “ancestor genre”. The genres C1 and C2 are ancestor genres of the genre C3. A plurality of items belonging to the same genre is not limited to items of which all genres ranging from the genres of level 1 to which the respective items belong to the genres of the lowest level are identical. A plurality of items belonging to the same genre may include items of which at least one set of genres among the genres of level 1 to the genres of the lowest level are the same. Specifically, the plurality of items maybe items of which all genres ranging from the genres of level 1 to genres of a certain level among genres of a level higher than the lowest level are identical. This is because the range of items belonging to the same genre becomes too narrow if only items belonging to the same genre of the lowest level are selected. Whether it is determined that a plurality of items belongs to the same genre when the genres thereof ranging from the genres of level 1 to genres of a certain level are identical may be set in advance by an administrator or may be determined according to a genre.

The genre ID is identification information of a genre defined by genre information. A parent genre ID is a genre ID of a parent genre of a genre defined by genre information. A child genre ID list is a list of genre IDs of child genres of a genre defined by genre information. The child genre ID list is set when a genre defined by genre information has a child genre. The out-of-multiple-purchase flag indicates whether a genre defined by genre information is the genre of such items that a plurality of items would probably be purchased by one user in the same period. When the out-of-multiple-purchase flag is set to ON for a certain genre, it means that a plurality of items of the genre would not be purchased in the same period. When the out-of-multiple-purchase flag is set to OFF for a certain genre, it means that a plurality of items of the genre would probably be purchased in the same period.

FIG. 4C is a diagram illustrating an example of contents registered in the shop information DB 12c. Shop information on a shop that is open at an online mall is registered in the shop information DB 12c. Specifically, attributes of a shop such as a shop ID, a shop name, a zip code, an address, a telephone number, an email address, and trading genre information are registered in the shop information DB 12c in association with each shop. The shop ID is identification information of a shop. The trading genre information is information indicating a genre of items traded by a shop is trading (items sold in a shop). Specifically, a genre ID of each genre of items traded by a shop is set in the trading genre information.

FIG. 4D is a diagram illustrating an example of contents registered in the item information DB 12d. Item information on items sold in an online mall is registered in the item information DB 12d. Specifically, attributes of an item such as an item ID, a shop ID, an item code, a genre ID, an item name, a uniform resource locator (URL) of an item image, an item description, and an item price are registered in the item information DB 12d in association with each item. The item ID (an example of information indicating the transaction object according to the present invention) is identification information of an item for allowing a shop or the like to manage items to be sold. The shop ID indicates a shop which is a distribution source of an item. The item code is a code number for identifying an item. The item code is, for example, a Japanese article number code (JAN) code. The genre ID is an ID of a genre to which an item belongs. The genre ID set in the item information is a genre ID of a genre (corresponding to a leaf node of a tree structure) that is basically defined in the lowest level. That is, items are classified into finest genres.

FIG. 4E is a diagram illustrating an example of contents registered in the browsing history DB 12e. A browsing history of an item page of an online mall is registered in the browsing history DB 12e. Specifically, an item ID, a browsing date and time, and a user ID are registered in the browsing history DB 12e in association whenever an item page is browsed. The item ID indicates an item of which the item page is browsed. The browsing date and time indicates the date and time when an item page was browsed. Specifically, the browsing date and time is the date and time when the electronic commerce server 1 transmitted an item page to the user terminal 3. The user ID indicates a user who browsed an item page.

FIG. 4F is a diagram illustrating an example of contents registered in the purchase history DB 12f. A purchase history of items purchased by a user is registered in the purchase history DB 12f. Specifically, an order code, a purchase date and time, a user ID, an item ID, a shop ID, an item code, the number of purchases, and the like are registered in the purchase history DB 12f in association with each purchase of items. The order code is identification information of an order assigned whenever an item is ordered. The user ID indicates a user who purchased an item. The item ID and the item code indicate an item which has been purchased. The shop ID indicates a shop which is a purchase destination. The number of purchases is the number of items which has been purchased.

FIG. 4G is a diagram illustrating an example of contents registered in the bookmark information DB 12g. Bookmark information (an example of reference list information according to the present invention) on the bookmark of a user is registered in the bookmark information DB 12g. Specifically, a user ID, an item ID, a registration date and time, and the like are registered in the bookmark information DB 12g in association whenever an item is registered in a bookmark. The user ID indicates a user who has registered an item in a bookmark. The item ID indicates an item registered in a bookmark. Moreover, the item ID is information corresponding to a reference to an item page of the item registered in the bookmark. Although the information of an actual reference to the item page is a URL, the URL of the item page can be specified from the item ID. The URL of the item page may be registered in the bookmark information DB 12g together with the item ID or in place of the item ID. The registration date and time indicates the date and time when an item was registered in the bookmark.

FIG. 4H is a diagram illustrating an example of contents registered in the bookmark registration/deletion history DB 12h. A bookmark registration/deletion history which is the history of registration and deletion of items in and from a bookmark is registered in the bookmark registration/deletion history DB 12h. Specifically, a user ID, an operation type, an operation date and time, an item ID, and the like are registered in the bookmark registration/deletion history DB 12h in association whenever an item is registered in or deleted from a bookmark. The user ID indicates a user who registered or deleted an item in or from a bookmark. The operation type indicates whether a user has registered an item in a bookmark or deleted from the bookmark. The operation date and time indicates the date and time when an item was registered in or deleted from a bookmark. The item ID indicates an item that was registered in or deleted from a bookmark.

Databases, for example, such as a catalog DB in which pieces of information (for example, an official name of an item, a genre ID of a genre of the item, or specifications of the item) on items are registered for each item code are also constructed in the storage unit 12.

Next, other pieces of information stored in the storage unit 12 will be described. Various types of data such as a hypertext markup language (HTML) document, an extensible markup language (XML) document, image data, text data, and an electronic document for displaying a web page are stored in the storage unit 12. Moreover, various setting values set by an administrator or the like are stored in the storage unit 12.

Moreover, various programs such as an operating system, a world wide web (WWW) server program, a database management system (DBMS), and an electronic commerce management program are stored in the storage unit 12. The electronic commerce management program is a program for executing various processes associated with electronic commerce. The programs may be acquired from another server apparatus through the network NW or may be recorded in a recording medium such as a digital versatile disc (DVD) and read by a drive device.

The input/output interface 13 is configured to perform interfacing processes between the communication unit 11 and the storage unit 12, and the system control unit 14.

The system control unit 14 is configured to include a CPU 14a, a read only memory (ROM) 14b, and a random access memory (RAM) 14c. The system control unit 14 is configured to function as an acquiring means, a predicting means, a determining means, a number-of-registrations acquiring means, a number-of-purchases acquiring means, a number determining means, and a share acquiring means according to the present invention, when the CPU 14a reads and executes various programs.

Also, the electronic commerce server 1 may be configured as a plurality of server apparatuses. For example, a server apparatus that performs processes associated with a bookmark, a server apparatus that performs processes associated with retrieving, ordering, and the like of items in an online mall, a server apparatus that performs a process of predicting a demand for items, a server apparatus that transmits a web page in response to a request from the user terminal 3, a server apparatus that manages databases, and the like may be connected to each other by a LAN or the like.

### 3. Operation of Electronic Commerce System

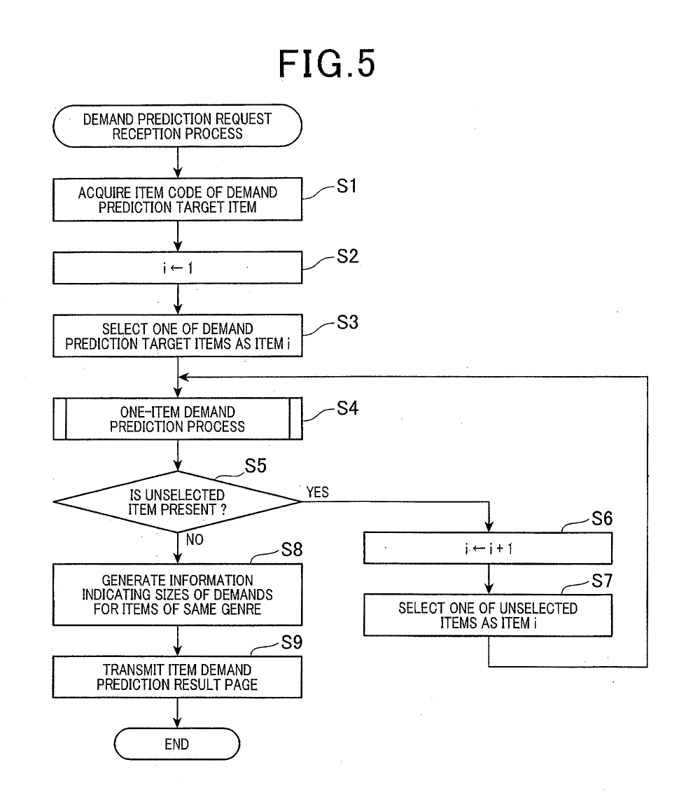

Next, the operation of the electronic commerce system S will be described with reference to FIGS. 5 to 7.

FIG. 5 is a flowchart illustrating a processing example of a demand prediction request reception process of the system control unit 14 of the electronic commerce server 1 according to the present embodiment.

An employee or the like of a shop operates the shop terminal 2 to request prediction of a demand for items. The shop terminal 2 transmits a demand prediction request to the electronic commerce server 1. A shop ID of a shop that requests prediction of a demand for items is set in the demand prediction request. The demand prediction request reception process starts when the electronic commerce server 1 receives a demand prediction request from the shop terminal 2.

First, the system control unit 14 acquires an item code of a demand prediction target item (step S1). For example, an employee or the like of a shop may designate an item code of a demand prediction target item and the system control unit 14 may acquire the designated item code from the shop terminal 2. Moreover, the system control unit 14 may acquire trading genre information from shop information that includes a shop ID set in the demand prediction request and acquire a plurality of item codes of items of genres traded by the shop that has requested demand prediction based on the trading genre information. Moreover, the system control unit 14 may acquire an item code of an item traded by the shop that has requested demand prediction from respective pieces of item information that include the shop ID set in the demand prediction request.

Subsequently, the system control unit 14 sets “1” to the index i of the demand prediction target item (step S2). Subsequently, the system control unit 14 selects one of the demand prediction target items as item i (step S3). Subsequently, the system control unit 14 executes a one-item demand prediction process (step S4).

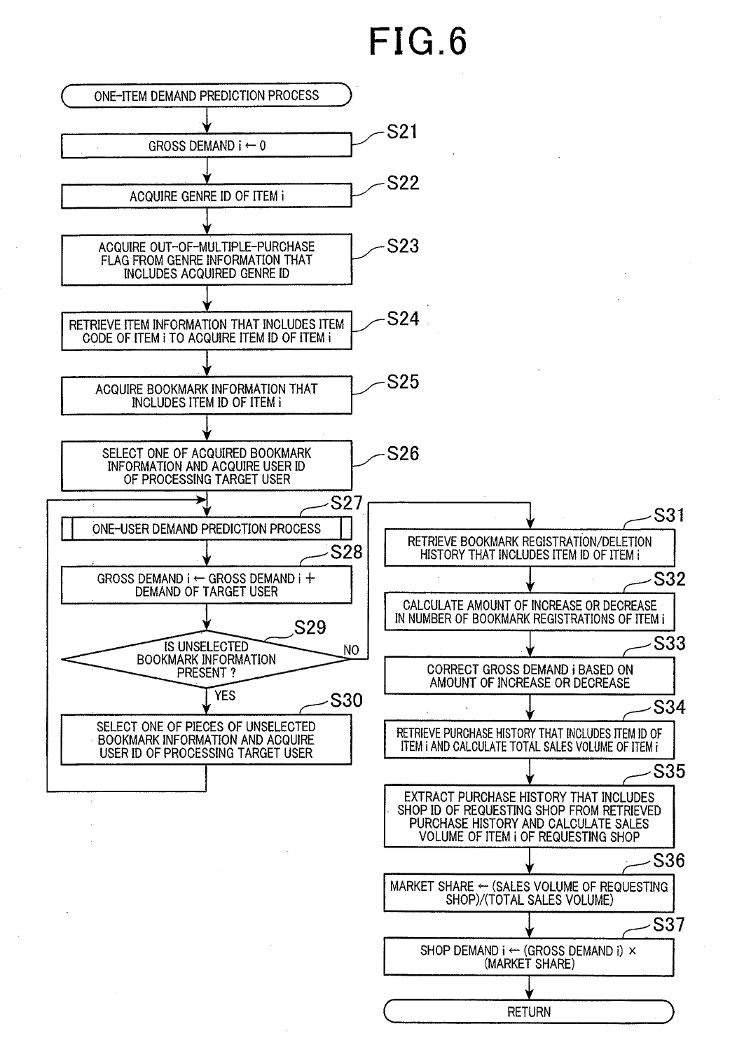

FIG. 6 is a flowchart illustrating a processing example of the one-item demand prediction process of the system control unit 14 of the electronic commerce server 1 according to the present embodiment. In the one-item demand prediction process, the system control unit 14 as a predicting means predicts a demand for item i.

First, the system control unit 14 sets “0” to a gross demand i indicating the value of the demand for item i in the entire online mall (step S21). Subsequently, the system control unit 14 acquires a genre ID corresponding to the item code of the item i from a catalog DB (step S22). Subsequently, the system control unit 14 acquires an out-of-multiple-purchase flag from the genre information that includes the acquired genre ID (step S23). Subsequently, the system control unit 14 retrieves the item information that includes the item code of the item i from the item information DB 12d to acquire an item ID from the respective pieces of retrieved item information (step S24). That is, the system control unit 14 acquires item IDs assigned to the item i in respective shops that sell the item i. Subsequently, the system control unit 14 as an acquiring means retrieves and acquires bookmark information that includes the item ID from the bookmark information DB 12g for each of the item IDs acquired in step S24 (step S25). That is, the system control unit 14 acquires all pieces of bookmark information indicating that the item i is registered as a bookmark.

Subsequently, the system control unit 14 selects one among the respective pieces of acquired bookmark information. The system control unit 14 acquires a user ID set in the selected bookmark information as a processing target user ID (step S26). Subsequently, the system control unit 14 executes a one-user demand prediction process (step S27).

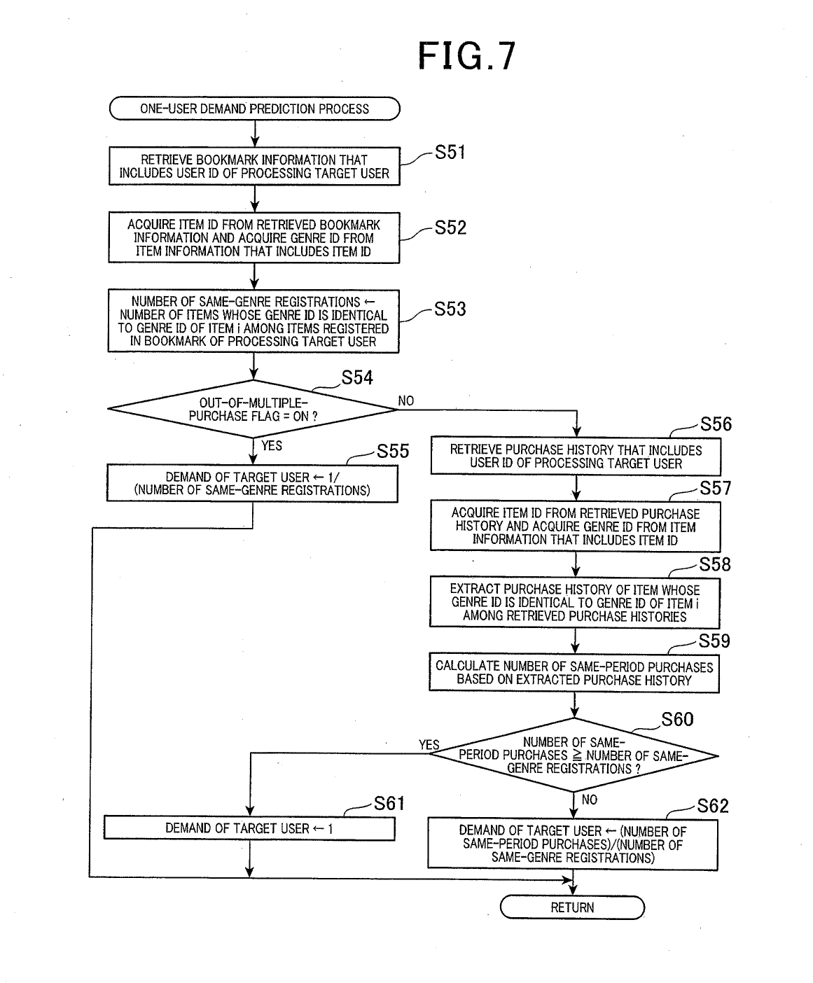

FIG. 7 is a flowchart illustrating a processing example of the one-user demand prediction process of the system control unit 14 of the electronic commerce server 1 according to the present embodiment. In the one-user demand prediction process, the system control unit 14 predicts the demand for the item i, of a processing target user. The processing example illustrated in FIG. 7 is a processing example when it is assumed that the per-user demand is one item.

First, the system control unit 14 retrieves bookmark information that includes the user ID of the processing target user from the item information DB 12d (step S51). Subsequently, the system control unit 14 acquires an item ID from the retrieved bookmark information. The system control unit 14 acquires a genre ID from item information that includes the item ID (step S52). Subsequently, the system control unit 14 as a number-of-registrations acquiring means calculates the number of genre IDs identical to the genre ID of the item i acquired in step S22 of the one-item demand prediction process among the genre IDs acquired in step S52. In this way, the system control unit 14 calculates the number of same-genre registrations which is the number of items of a genre to which the item i belongs among the items that the target user has registered in the bookmark (step S53).

Subsequently, the system control unit 14 as a determining means determines whether the out-of-multiple-purchase flag acquired in step S23 of the one-item demand prediction process is set to ON (step S54). In this case, when it is determined that the out-of-multiple-purchase flag is set to ON (YES in the step S54), the system control unit 14 sets 1/(Number of same-genre registrations) as a predicted value of the demand of the target user (step S55).

On the other hand, when it is determined that the out-of-multiple-purchase flag is set to OFF (NO in the step S54), the system control unit 14 retrieves a purchase history that includes the user ID of the processing target user (step S56). Subsequently, the system control unit 14 acquires an item ID from the respective retrieved purchase histories. The system control unit 14 acquires a genre ID from the item information that includes the acquired item ID (step S57). Subsequently, the system control unit 14 extracts a purchase history in which the item ID included in the purchase history is identical to the genre ID of the item i acquired in step S22 of the one-item demand prediction process among the retrieved purchase histories (step S58). That is, the system control unit 14 extracts a purchase history indicating that the target user has purchased an item of a genre to which the item i belongs.

Subsequently, the system control unit 14 as a number-of-purchases acquiring means calculates a number of same-period purchases based on the extracted purchase histories (step S59). Specifically, every period (for example, one hour, one day, one week, one month, or the like) regarded as the same period from the present, the system control unit 14 specifies a purchase history of which the purchase date and time belongs to the period. Subsequently, the system control unit 14 calculates the sum of the numbers of purchases included in the respective purchase histories specified in the respective periods to calculate the number of purchases in each period. For example, it is assumed that the period regarded as the same period is one day. In this case, the system control unit 14 calculates the number of purchases of yesterday, the number of purchases of 2 days before today, the number of purchases of 3 days before today, and so on. The number of days in which the number of purchases is calculated is set in advance, for example. Subsequently, the system control unit 14 calculates the number of same-period purchases by calculating the average of the numbers of purchases equal to or larger than 1 among the numbers of purchases calculated in the respective periods. Since the number of same-period purchases is the number of purchases of items of a certain genre in a period when a user has purchased an item of the genre, a period in which no item was purchased (the period where the number of purchases is 0) is not counted in the calculation of the number of same-period purchases. For example, it is assumed that the period regarded as the same period is one day, and the numbers of daily purchases from yesterday to one week before are calculated. In this case, if the respective numbers of purchases are 0, 0, 3, 0, 0, and 1, the number of same-period purchases is (1+3)/2=2. The electronic commerce server 1 may use the number of purchases in a period from the present to the immediate when the user has purchased an item as the number of same-period purchases, for example, rather than calculating the average of the numbers of purchases. For example, in the above example, the number of same-period purchases is 3 which is the number of purchases of three days before. Moreover, for example, the electronic commerce server 1 may use the largest number of purchases among the numbers of purchases calculated in the respective periods as the number of same-period purchases. Moreover, the number of items that the user has purchased at the same time among the items of a genre to which the item i belongs may be used as the number of same-period purchases. That is, the system control unit 14 may calculate the number of same-period purchases by calculating the numbers of purchases of items of a genre to which the item i belongs with respect to the purchase histories, of which the purchase dates are the same, to calculate the average of the numbers of purchases or to specify the largest number of purchases, for example.

When the number of same-period purchases is calculated, the system control unit 14 as a number determining means determines whether the number of same-period purchases is equal to or larger than a number of same-genre registrations (step S60). In this case, when the number of same-period purchases is determined to be equal to or larger than the number of same-genre registrations (YES in the step S60), the system control unit 14 sets “1” as a predicted value of the demand of the target user (step S61). On the other hand, when the number of same-period purchases is determined to be smaller than the number of same-genre registrations (NO in the step S60), the system control unit 14 sets (Number of same-period purchases)/(Number of same-genre registrations) as the predicted value of the demand of the target user (step S62). Upon finishing the setting of the predicted value of the demand of the target user (step S65, S61, or S62), the system control unit 14 ends the one-user demand prediction process.

Subsequently, as illustrated in FIG. 6, the system control unit 14 adds the predicted value of the demand of the target user set in the one-user demand prediction process to the gross demand i (step S28). Subsequently, the system control unit 14 determines whether there is bookmark information that has not been selected among the pieces of bookmark information acquired in step S25 (step S29). In this case, when it is determined that there is bookmark information that has not been selected (YES in the step S29), the system control unit 14 selects one among the pieces of bookmark information that have not been selected. The system control unit 14 acquires a user ID set in the selected bookmark information as a processing target user ID (step S30). Subsequently, the system control unit 14 proceeds to step S27. The system control unit 14 repeats the processes of steps S27 to S30 to calculate the sum of predictive values of the demands of respective users who have registered the item i in the bookmark as the gross demand i.

When it is determined that all pieces of bookmark information have been selected (NO in the step S29), the system control unit 14 retrieves bookmark registration/deletion history that includes the item IDs acquired in step S24 from the bookmark registration/deletion history DB 12h for each item ID of the acquired items i (step S31). That is, the system control unit 14 retrieves the history of the item i registered in and deleted from the bookmark. In this case, the system control unit 14 retrieves the bookmark registration/deletion history only of which the operation date and time belongs to a predetermined period (for example, a period of one week from the present, a period of one month from the present, or the like). Subsequently, the system control unit 14 calculates an amount of increase or decrease in the number of bookmark registrations of the item i based on the retrieved bookmark registration/deletion histories (step S32). Specifically, the system control unit 14 calculates the increase or decrease by subtracting the number of bookmark registration/deletion histories of which the operation type indicates deletion from the number of bookmark registration/deletion histories of which the operation type indicates registration. Subsequently, the system control unit 14 corrects the gross demand i based on the calculated amount of increase or decrease (step S33). For example, when the amount of increase or decrease is negative, the system control unit 14 may multiply the amount of increase or decrease by a predetermined coefficient and add the multiplication result to the gross demand i.

Subsequently, the system control unit 14 retrieves a purchase history that includes the item code of the item i from the purchase history DB 12f. In this case, the system control unit 14 retrieves the purchase history only of which the purchase date and time belongs to a predetermined period. The system control unit 14 calculates the total sales volume of the item i in the predetermined period by calculating the sum of the numbers of purchases included in the respective retrieved purchase histories (step S34). Subsequently, the system control unit 14 extracts a purchase history that includes the shop ID of the shop that has requested the item demand prediction among the retrieved purchase histories. The system control unit 14 calculates the sales volume of the item i in the predetermined period of the shop that has requested the item demand prediction by calculating the sum of the numbers of purchases included in the respective extracted purchase histories (step S35). Subsequently, the system control unit 14 as a share acquiring means calculates the market share of the item i, of the shop that requested the item demand prediction by dividing the sales volume of the shop that has requested the item demand prediction by the total sales volume (step S36). Subsequently, the system control unit 14 calculates a shop demand i indicating the value of the demand of the shop that has requested the item demand prediction by multiplying the market share by the gross demand i (step S37). Upon finishing this process, the system control unit 14 ends the one-item demand prediction process.

Subsequently, as illustrated in FIG. 5, the system control unit 14 determines whether there is an item that has not been selected among the demand prediction target items (step S5). In this case, when it is determined that there is an item that has not been selected (YES in the step S5), the system control unit 14 adds “1” to the index i (step S6). Subsequently, the system control unit 14 selects one of the items that have not been selected as the item i (step S7). Subsequently, the system control unit 14 proceeds to step S4. The system control unit 14 repeats the processes of steps S4 to S7 to calculate the shop demand of the respective demand prediction target items.

When it is determined that all items have been selected (NO in the step S5), the system control unit 14 generates information indicating the predicted demand based on the shop demands of the respective items (step S8). In this case, when a plurality of items belonging to the same genre is present in the demand prediction target items, the system control unit 14 generates information indicating the sizes of the demands for the items belonging to the same genre. For example, the system control unit 14 may generate information indicating the values of the shop demands at they are as illustrated in FIG. 2A. Moreover, for example, the system control unit 14 may calculate the ratio of shop demands and generate information indicating the ratio as illustrated in FIG. 2B. Further, for example, the system control unit 14 may compare the shop demands and generate such information as illustrated in FIG. 2C. Furthermore, when there is no item belonging to the same genre as a certain item, the system control unit 14 may generate information indicating the value of the shop demand as it is. Furthermore, for example, the system control unit 14 may add information on the amount of increase or decrease in the number of bookmark registrations to the information indicating the demand as illustrated in FIGS. 2D and 2E.

Subsequently, the system control unit 14 generates an item demand prediction result page including the information indicating the demand and transmits the generated item demand prediction result page to the shop terminal 2 that has transmitted the demand prediction request (step S9). Upon finishing this process, the system control unit 14 ends the demand prediction request reception process.

The system control unit 14 acquires the genre IDs from the catalog DB or the item information DB 12d in steps S22, S53, and S57 and determines whether the acquired genre IDs are identical in steps S53 and S58. That is, the system control unit 14 specifies items belonging to the same genre as the demand prediction target item by comparing the genres of the lowest level at which items are classified. However, the system control unit 14 may determine whether the genre IDs of the ancestor genres of genres indicated by the genre IDs acquired from the catalog DB or the item information DB 12d are identical. That is, the system control unit 14 may specify items belonging to the same genre as the demand prediction target item by a genre of a higher level than the lowest level rather than by the genre of the lowest level. This is because the range of items belonging to the same genre becomes too narrow if only items belonging to the same genre of the lowest level are selected. The same is true when a plurality of items belonging to the same genre is specified in step S8. A parent genre of a genre defined by the genre information that is registered in the genre information DB 12b can be specified by a parent genre ID included in the genre information. Thus, it is possible to acquire a genre ID of an ancestor genre from the genre information DB 12b using the parent genre ID as a clue.

As described above, according to the present embodiment, the system control unit 14 of the electronic commerce server 1 acquires a plurality of pieces of bookmark information from the bookmark information DB 12g and predicts the demand for items based on the acquired bookmark information. Thus, it is possible to predict the demand more accurately than the demand prediction based on the number of past purchases and the demand prediction based on the number of accesses to an item page, for example.

Moreover, the system control unit 14 predicts the sizes of the demands for a plurality of items of which at least one set of genres among a plurality of genres are the same. Thus, it is possible to compare the demands for a plurality of items.

Moreover, the system control unit 14 predicts the demand for items based on the bookmark information acquired from the bookmark information DB 12g and the bookmark registration/deletion history registered in the bookmark registration/deletion history DB 12h. Thus, it is possible to improve the demand prediction accuracy further by taking the bookmark registration/deletion history further into consideration.

Moreover, the system control unit 14 determines whether the out-of-multiple-purchase flag of a genre to which the demand prediction target item belongs is set to ON and calculates the number of same-genre registrations of items of a genre to which the demand prediction target item belongs for each user. When it is determined that the out-of-multiple-purchase flag is set to OFF, the system control unit 14 sets a demand corresponding to one user as the demand of each user. When the out-of-multiple-purchase flag is set to ON, the system control unit 14 sets a division of the demand corresponding to one user by the number of same-genre registrations as the demand of each user, calculates the sum of the demands for the prediction target item, of respective users who have registered the item in the bookmark, and predicts the demand corresponding to the sum. Thus, the demand can be predicted by taking the fact that, even when a plurality of items of such a genre that only one item would probably be purchased in the same period by one user is registered in a bookmark of one user, the user would probably purchase one of the items into consideration. Therefore, it is possible to improve the demand prediction accuracy.

Moreover, the system control unit 14 calculates, for each user, the number of same-period purchases of an item of a genre to which a prediction target item belongs based on a purchase history registered in the purchase history DB 12f and determines for each user whether the number of same-period purchases is equal to or larger than the number of same-genre registrations. When the out-of-multiple-purchase flag of a genre to which the demand prediction target item belongs is set to OFF, the system control unit 14 sets the demand corresponding to one user as the demand of a user of which the number of same-period purchases is determined to be equal to or larger than the number of same-genre registrations. The system control unit 14 sets a demand obtained by multiplying the demand corresponding to one user by the number of same-period purchases and dividing the multiplication result by the number of same-genre registrations as the demand of a user of which the number of same-period purchases is determined to be smaller than the number of same-genre registrations. Thus, when a plurality of items of such a genre that a plurality of items would probably be purchased in the same period by one user is registered in the bookmark of one user, the demand can be predicted by taking the purchasing trends of the respective users into consideration. Therefore, it is possible to improve the demand prediction accuracy.

Moreover, the system control unit 14 calculates the market share of a demand prediction target item, of a shop that has requested demand prediction among a plurality of shops that sells the demand prediction target item and predicts the demand of the shop that has requested demand prediction based on the market share and the bookmark information acquired from the bookmark information DB 12g. Thus, it is possible to predict the demand for a shop that wants to know a demand.

In the above embodiment, the transaction object of the present invention is applied to an item. However, the transaction object may be applied to a service. Moreover, the present invention may be applied to a system in which reservation of services can be made as an electronic commerce system. Examples of service reservations include reservation of lodging facilities, reservation of athletic facilities such as golf links, and reservation of seats of transportation facilities.

### REFERENCE SIGN LIST

1 electronic commerce server
2 shop terminal
3 user terminal
11 communication unit
12 storage unit
12a membership information DB
12b genre information DB
12c shop information DB
12d item information DB
12e browsing history DB
12f purchase history DB
12g bookmark information DB
12h bookmark registration/deletion history DB
13 input/output interface
14 system control unit
14a CPU
14b ROM
14c RAM
15 system bus
NW network
S electronic commerce system

1-9. (canceled)

10. An information processing apparatus comprising:
an acquiring means that acquires a plurality of pieces of reference list information from a storing means that stores, for each user, reference list information indicating transaction objects registered by users in a reference list that holds references to information on transaction objects; and
a predicting means that predicts a demand for a transaction object based on the reference list information acquired by the acquiring means.

11. The information processing apparatus according to claim 10,
wherein the predicting means predicts sizes of demands for a plurality of transaction objects whose at least one set of classes among a plurality of classes of transaction objects belong to the same class.

12. The information processing apparatus according to claim 10,
wherein the predicting means predicts a demand for a transaction object based on the reference list information acquired by the acquiring means and a deletion history stored in a deletion history storing means that stores a deletion history of the transaction object from the reference list by the user.

13. The information processing apparatus according to claim 10, further comprising:
a determining means that determines whether a class to which a demand prediction target transaction object belongs among a plurality of classes of transaction objects is such a class of transaction objects for which a plurality of transaction objects is purchased in the same period by one user; and
a number-of-registrations acquiring means that acquires, for each user, a number of registrations in the reference list, of transaction objects of the class to which the prediction target transaction object belongs,
wherein the predicting means calculates the sum of demands for the prediction target transaction object, of respective users, which has been registered in the reference list, predicts a demand corresponding to the sum, sets a predetermined demand as the demand of each user when the determining means determines that the class of the transaction object is such a class for which a plurality of transaction objects are purchased, and sets the demand of each user based on the number of registrations acquired for each user by the number-of-registrations acquiring means when the determining means determines that the class of the transaction object is not such a class for which a plurality of transaction objects is purchased.

14. The information processing apparatus according to claim 13, further comprising:
a number-of-purchases acquiring means that acquires, for each user, the number of purchases, in the same period, of transaction objects of a class to which the prediction target transaction object belongs based on a purchase history stored in a purchase history storing means that stores information indicating the class of a transaction object purchased by the user, information indicating the user who has purchased the transaction object, and a purchase date and time in association with each other as a purchase history; and
a number determining means that determines, for each user, whether the number of purchases acquired by the number-of-purchases acquiring means is equal to or larger than the number of registrations acquired by the number-of-registrations acquiring means,
wherein when the determining means determines that the class of the transaction object is such a class for which a plurality of transaction objects are purchased, the predicting means sets the predetermined demand as the demand of a user whose number of purchases is determined by the number determining means to be equal to or larger than the number of registrations, and sets a demand smaller than the predetermined demand as the demand of a user whose number of purchases is determined by the number determining means to be smaller than the number of registrations based on the number of purchases and the number of registrations.

15. The information processing apparatus according to claim 10, further comprising:
a share acquiring means that acquires a market share of a demand prediction target transaction object, of a seller who has requested demand prediction among a plurality of sellers who sells the demand prediction target of transaction object,
wherein the predicting means predicts a demand of the seller who has requested demand prediction based on the reference list information acquired by the acquiring means and the market share acquired by the share acquiring means.

16. An information processing method, which is executed by a computer, comprising:
an acquiring step of acquiring a plurality of pieces of reference list information from a storing means that stores, for each user, reference list information indicating transaction objects registered by users in a reference list that holds references to information on transaction objects; and
a predicting step of predicting a demand for a transaction object based on the reference list information acquired in the acquiring step.

17. The information processing apparatus according to claim 11,
wherein the predicting means predicts a demand for a transaction object based on the reference list information acquired by the acquiring means and a deletion history stored in a deletion history storing means that stores a deletion history of the transaction object from the reference list by the user.

18. The information processing apparatus according to claim 11, further comprising:
a determining means that determines whether a class to which a demand prediction target transaction object belongs among a plurality of classes of transaction objects is such a class of transaction objects for which a plurality of transaction objects is purchased in the same period by one user; and
a number-of-registrations acquiring means that acquires, for each user, a number of registrations in the reference list, of transaction objects of the class to which the prediction target transaction object belongs,
wherein the predicting means calculates the sum of demands for the prediction target transaction object, of respective users, which has been registered in the reference list, predicts a demand corresponding to the sum, sets a predetermined demand as the demand of each user when the determining means determines that the class of the transaction object is such a class for which a plurality of transaction objects are purchased, and sets the demand of each user based on the number of registrations acquired for each user by the number-of-registrations acquiring means when the determining means determines that the class of the transaction object is not such a class for which a plurality of transaction objects is purchased.

19. The information processing apparatus according to claim 12, further comprising:
a determining means that determines whether a class to which a demand prediction target transaction object belongs among a plurality of classes of transaction objects is such a class of transaction objects for which a plurality of transaction objects is purchased in the same period by one user; and
a number-of-registrations acquiring means that acquires, for each user, a number of registrations in the reference list, of transaction objects of the class to which the prediction target transaction object belongs,
wherein the predicting means calculates the sum of demands for the prediction target transaction object, of respective users, which has been registered in the reference list, predicts a demand corresponding to the sum, sets a predetermined demand as the demand of each user when the determining means determines that the class of the transaction object is such a class for which a plurality of transaction objects are purchased, and sets the demand of each user based on the number of registrations acquired for each user by the number-of-registrations acquiring means when the determining means determines that the class of the transaction object is not such a class for which a plurality of transaction objects is purchased.

20. The information processing apparatus according to claim 11, further comprising:
a share acquiring means that acquires a market share of a demand prediction target transaction object, of a seller who has requested demand prediction among a plurality of sellers who sells the demand prediction target of transaction object,
wherein the predicting means predicts a demand of the seller who has requested demand prediction based on the reference list information acquired by the acquiring means and the market share acquired by the share acquiring means.

21. The information processing apparatus according to claim 12, further comprising:
a share acquiring means that acquires a market share of a demand prediction target transaction object, of a seller who has requested demand prediction among a plurality of sellers who sells the demand prediction target of transaction object,
wherein the predicting means predicts a demand of the seller who has requested demand prediction based on the reference list information acquired by the acquiring means and the market share acquired by the share acquiring means.

22. The information processing apparatus according to claim 13, further comprising:
a share acquiring means that acquires a market share of a demand prediction target transaction object, of a seller who has requested demand prediction among a plurality of sellers who sells the demand prediction target of transaction object,
wherein the predicting means predicts a demand of the seller who has requested demand prediction based on the reference list information acquired by the acquiring means and the market share acquired by the share acquiring means.

23. The information processing apparatus according to claim 14, further comprising:
a share acquiring means that acquires a market share of a demand prediction target transaction object, of a seller who has requested demand prediction among a plurality of sellers who sells the demand prediction target of transaction object,
wherein the predicting means predicts a demand of the seller who has requested demand prediction based on the reference list information acquired by the acquiring means and the market share acquired by the share acquiring means.
